(19) United States
(12) Patent Application Publication
(10) Pub. No.: US 2024/0182661 A1
(43) Pub. Date: Jun. 6, 2024

(54) METHOD FOR PRODUCING FOAM PARTICLES FROM EXPANDED THERMOPLASTIC ELASTOMER

(71) Applicant: BASF SE, Ludwigshafen am Rhein (DE)

(72) Inventors: Lisa Marie Schmidt, Lemfoerde (DE); Matthias Goldbeck, Muenster (DE); Uwe Keppeler, Hochdorf-Assenheim (DE); Franziska Dennhardt, Lemfoerde (DE); Theresa Huelsmann, Lemfoerde (DE); Florian Tobias Rapp, Ludwigshafen (DE)

(73) Assignee: BASF SE, Ludwigshafen am Rhein (DE)

(21) Appl. No.: 18/550,450

(22) PCT Filed: Mar. 10, 2022
(86) PCT No.: PCT/EP2022/056174

§ 371 Date: Sep. 13, 2023

(30) Foreign Application Priority Data
Mar. 15, 2021 (EP) 21162613.0

(51) Int. Cl. C08J 9/224; B29B 7/48; B29B 9/06; B29B 9/12; B29B 9/16; B29K 21/00; B29K 75/00; B29K 105/04; C08J 9/12; C08J 9/18

(52) U.S. Cl. CPC C08J 9/224; B29B 9/065; B29B 9/12; B29B 9/16; C08J 9/122; C08J 9/18; B29B 7/48; B29B 2009/163; B29K 2021/003; B29K 2075/00; B29K 2105/04; C08J 2201/03; C08J 2203/06; C08J 2375/08

(57) ABSTRACT

A process for producing foam particles from expanded thermoplastic elastomer involves (a) mixing a thermoplastic elastomer melt with a blowing agent in an extruder; (b) pressing the thermoplastic elastomer melt mixed with the blowing agent through a die plate into a pelletizing chamber; and (c) comminuting the thermoplastic elastomer melt pressed through the die plate into individual pellets. A liquid flows through the pelletizing chamber, and the pressure and temperature of the liquid are chosen such that the pellets are expanded to a desired degree in the liquid by the blowing agent and solidify to form foam particles. Additionally, the liquid in the pelletizing chamber contains wax which accumulates on the surface of the pellet during the cutting and expansion in the pelletizing chamber; and/or after separation from the liquid and drying of the foam particles, a wax is applied to the foam particles of expanded thermoplastic elastomer.

The invention relates to foam particles composed of an expanded thermoplastic elastomer, and to a process for producing such particles.

Foam particles composed of expanded thermoplastic elastomer may be used in many sectors, for example in the production of molded articles such as packaging materials, seat cushions, car seats, mattresses, floor coverings, tires, saddles or else soles of running shoes. For this purpose, the foam particles, for example, are introduced into a mould, where they are contacted with steam or heated such that they fuse to one another on the outside.

Since the production of the molded articles from the foam particles is typically at different sites than the production of the foam particles, it is necessary to transport these from the site of production of the foam particles to the site of molded article production. The transport is typically effected in large containers, for example bigbags or octabins. These are filled and emptied via conveying devices, with the material of the foam particles and geometry and bulk density of the foam particles having a major influence on transport characteristics. Even when the production of the foam particles and the production of the molded articles take place in adjacent plants, it is necessary first to store the material before it can be processed further. Irrespective of whether the foam particles are stored in a large container or a fixed storage vessel, they can agglomerate very significantly, such that removal from the large container or storage vessel with conveying devices known to the person skilled in the art (for example pneumatic suction probes) is not possible without additional mechanical loosening.

The production of molded articles from such foam particles is described, for example, in EP-A 2 671 633, wherein here the foam particles are transported into feeds to the shaping mold by adding water or an additional lubricant, for example, in order that the foam particles do not stick to one another and hence block the conduits, it being insufficient according to EP-A 2 671 633 when an internal or external lubricant is added in the course of production.

Processes for producing foam particles from a thermoplastic polyurethane are described. for example, in WO-A 2007/082838. In this case, one option is to first produce the pellets from the thermoplastic polyurethane and then impregnate these with a blowing agent in a suspension under pressure and at a temperature above the softening temperature and to expand them by decompression to give form particles. Alternatively, the blowing agent may also be added in an extruder and the foam particles are produced by decompression in an underwater pelletization. In underwater pelletization, the water typically contains a pelletizing aid that remains on the foam particles. However, this is insufficient to prevent blocking in the storage vessel or large container.

A further disadvantage of the processes known from the prior art is that even a small amount of lubricant which is added in the course of production can have the effect of hindering the welding of the foam particles to give the desired molded article.

It was therefore an object of the present invention to provide a process for producing foam particles that can be processed further without risk of blocking in the course of storage.

The object is achieved by a process for producing foam particles, comprising:
(a) mixing a thermoplastic elastomer melt with a blowing agent in an extruder;
(b) pressing the thermoplastic elastomer melt mixed with the blowing agent through a die plate into a pelletizing chamber;
(c) comminuting the thermoplastic elastomer melt mixed with the blowing agent that has been pressed through the die plate into individual pellets,
wherein a liquid flows through the pelletizing chamber, and the pressure and temperature of said liquid are chosen such that the pellets are expanded to a desired degree in the liquid by means of the blowing agent present and solidify to form foam particles, wherein at least one of the following features is encompassed:
(i) the liquid in the pelletizing chamber comprises wax, which accumulates on the surface of the pellet during the cutting and expansion in the pelletizing chamber,
(ii) after separation from the liquid and drying of the foam particles, a wax is applied to the foam particles of expanded thermoplastic elastomer.

The process produces foam particles composed of an expanded thermoplastic elastomer having a surface to which a wax has been applied, wherein the proportion of wax is 0.001% to 0.5% by weight.

The wax acts as a lubricant which prevents sticking of the foam particles, such that they can be removed and conveyed from the containers used for storage and transport, for example cardboard drums, silos, bigbags or octabins, without blocking. A further advantage of the use of a wax as lubricant is that it does not hinder the subsequent processing of the foam particles and, in the above-described concentration range, more particularly, does not have any adverse effect on the welding of the particles to give the molded article.

Should it nevertheless be necessary to remove the wax from the surface of the foam particles, it is possible, for example, to remove this by a suitable wash, for example by a mechanical cleaning, preferably in the presence of water. Since the foam particles, for molded article production, are introduced into a mold and steam is then passed through the mold, such that the foam particles are welded to one another to give the molded article, it is not absolutely necessary to dry the foam particles after the wax has been washed off. This has the further advantage that the water used to wash the wax off, after the wash, can also be used as lubricant, and hence the foam particles can be conveyed from the wash position into the molded article by the water adhering thereto without blocking.

Irrespective of whether the liquid in the pelletizing chamber comprises the wax that accumulates on the foam particles during the cutting and expansion in the pelletizing chamber or the wax is applied after separation from the liquid and drying of the foam particles, there is preferably no wax as additive in the polymer, such that, in addition to any wax that has diffused from the surface into the particles, no further wax can diffuse from the foam particles to the surface and be deposited again after it has been washed off.

It is particularly advantageous to apply the wax to the surface of the foam particles or the pellets in the apparatus in which the pellets expand through decompression of the blowing agent to give the foam particles, since blocking can already occur in any transport without wax acting as a lubricant at the surface. It is particularly preferable, therefore, when the liquid in the pelletizing chamber comprises the wax which accumulates on the surface of the pellet during the cutting and expansion in the pelletizing chamber.

The foam particles are produced by extrusion methods known to the person skilled in the art, as described, for example, in WO-A 2007/082838 or WO-A 94/20568.

For production of the foam particles, one option is to add pellets of the thermoplastic elastomer to the extruder, as described, for example, in WO-A 2013/153190. Alternatively, it is also possible to add the starting materials required for production of the thermoplastic elastomer, especially the monomers from which the thermoplastic elastomer has been made, and any additives such as catalysts, plasticizers, stabilizers or dyes, to the extruder and then to foam the material, as described, for example, in WO-A 2015/055811.

When the starting materials required for production of the thermoplastic elastomer are added to the extruder, these are converted to the thermoplastic elastomer in the extruder feed, producing the thermoplastic elastomer melt. The production is effected here under the conditions known to the person skilled in the art for production of a thermoplastic elastomer in an extruder. On completion of conversion, it is then possible to add the blowing agent via a suitable addition site in step (a) and to mix it with the thermoplastic elastomer melt in the extruder.

When the thermoplastic elastomer is produced not in an extruder but in some other reactor, it is likewise possible to introduce the thermoplastic melt thus produced into an extruder and to mix it with the blowing agent therein.

However, it is preferable first to produce pellets from the thermoplastic elastomer in a manner known to the person skilled in the art and to supply these to the extruder in which the blowing agent is added. In this case, the pellet is first compressed and at the same time heated in the extruder intake zone, such that it begins to melt. Thereafter, the pellets are melted completely. After the melting, it is then possible to add the blowing agent, which is mixed into the thermoplastic elastomer melt by means of a suitable screw geometry.

The rotation of the screw in the extruder homogeneously mixes the thermoplastic elastomer melt with the blowing agent and transports it to the downstream unit that follows the extruder. The downstream unit may already be the die plate or an apparatus upstream of the die plate, for example a melt pump, a slide valve, a static mixer or a melt filter, or combinations of these.

Suitable blowing agents are, for example, halogenated hydrocarbons, saturated aliphatic hydrocarbons or inorganic gases, for example saturated hydrocarbons having 3 to 8 carbon atoms, nitrogen, air, ammonia, carbon dioxide or mixtures thereof.

The thermoplastic elastomer melt mixed with the blowing agent is then pressed into a pelletizing chamber through the die plate in step (b). In the pelletizing chamber, a blade runs across the die plate, with which the exiting thermoplastic elastomer melt mixed with the blowing agent is cut into pellets.

A liquid flows through the pelletizing chamber, such that the thermoplastic elastomer melt is pressed through the die plates directly into the liquid. The pressure of the liquid flowing through the pelletizing chamber is chosen such that the thermoplastic elastomer melt exiting through the die plate is expanded until the desired density for the foam thus formed is attained. The pressure of the liquid that flows through the pelletizing chamber is preferably within a range from 1 to 20 bar, more preferably within a range from 5 to 15 bar and especially within a range from 7 to 12 bar.

The temperature of the liquid is chosen such that the exiting thermoplastic elastomer melt solidifies in the liquid to give the foam particles, although the melt must not solidify until after the desired expansion. The temperature here depends on the thermoplastic elastomer used and is preferably 25 to 90° C., more preferably 30 to 60° C. and especially 35 to 50° C.

The foam particles thus produced are discharged from the pelletizing chamber with the liquid that flows through the pelletizing chamber and separated from the liquid in a suitable apparatus for a solid/liquid separation. After separation from the liquid, the foam particles may be dried. The drying can be effected in any suitable dryer known to those skilled in the art, for example heated fluidized bed or silo drying.

In order that the thermoplastic elastomer melt cannot solidify in the die plate and hence block the holes of the die plate, it is preferable when the die plate is heated. The temperature of the die plate here is preferably within a range from 20 to 110° C. above the melting temperature of the thermoplastic elastomer, more preferably within a range from 50 to 90° C. above the melting temperature of the thermoplastic elastomer, and especially within a range from 60 to 80° C. above the melting temperature of the thermoplastic elastomer. The melting temperature here, according to DIN EN ISO 11357-3:2018, refers to the temperature corresponding to the highest peak in dynamic differential calorimetry (DSC).

The liquid that flows through the pelletizing chamber is preferably water and optionally comprises a pelletizing aid. The pelletizing aid serves more particularly to prevent the foam particles from agglomerating in the liquid, so that they remain as individual pellets in the liquid. Examples of suitable pelletizing aids include surfactants, water or white oils, especially waxes or white oils.

In the first variant (i) in which the wax is dispersed in the liquid that flows through the pelletizing chamber, the wax is applied to the pellets during the expansion and solidification to give the foam particles. A uniform distribution of the wax on the surface of the foam particles results more particularly from homogeneous distribution of the lubricant in the liquid with good mixing of the liquid, and from mixing of the particles in the liquid during the expansion and solidification and subsequent transport out of the pelletizing chamber. The mixing especially results from the flow of the liquid through the pelletizing chamber.

The movement of the foam particles in the liquid results in accumulation of the wax at the surface of the foam particles, which penetrates to a small degree at most into the foam particles. This has the advantage over the use of the wax as additive in the production of the polymer that, in a component which is manufactured from the foam particles, wax can diffuse to the surface to a very small degree only when wax has diffused into the foam particles during the production of the expanded foam particles.

In order to obtain a proportion of wax at the surface of the foam particles in the range from 0.001% to 0.5% by weight, based on the total mass of the foam particles, it is preferable when the liquid that flows through the pelletizing chamber comprises 0.0005% to 0.5% by weight, preferably 0.001% to 0.25% by weight and especially 0.0025% to 0.1% by weight of wax, based on the total mass of the liquid.

When the wax used as lubricant is present in the liquid that flows through the pelletizing chamber, this wax more preferably also acts as pelletizing aid. This has the further advantage that, aside from the wax that acts as lubricant which accumulates on the surface of the foam particles, there is no need for any further pelletizing aid that can contaminate the foam particles and may need to be removed therefrom prior to further processing.

The wax may be present here in solid form in the liquid in a dispersion or in liquid form in the liquid in an emulsion. When the wax is dispersed in solid form in the liquid that flows through the pelletizing chamber, it is particularly preferable when the wax is present as powder with a particle diameter D50 in the range from 10 to 50 μm. It may be necessary here, in order to keep the wax in dispersion, additionally to add a suspension aid. Particle diameter in the context of the present invention is understood to mean nonspherical particles of the geometric equivalent diameter corresponding to the spherical diameter of the sphere of the same volume.

In a second variant (ii), the wax acting as a lubricant may also be applied after separation from the liquid and optionally drying of the foam particles. For this purpose, it is possible either to apply the pellets in the form of a suspension or solution or alternatively for them to be in solid form, in which case the wax is in the form of a fine powder. Application after the expansion of the pellets can be effected either alternatively or additionally to application during expansion and solidification in the pelletizing chamber. Additional application is required when the amount of lubricant that has been applied to the foam particles in the pelletizing chamber during the expansion and solidification is insufficient.

When the wax is applied in the form of a suspension or solution, the composition of the liquid comprising the wax more preferably corresponds to the above-described composition of the liquid in which the foam particles are impregnated in the pelletizing chamber in the first variant (i).

However, it is preferable when, in the second variant (ii), the wax is applied to the foam particles in the form of a powder. In this case, it is particularly preferable when the wax and the foam particles are introduced into a vessel, which is then closed and subsequently agitated, such that the foam particles impact one another and the wall of the vessel. For this purpose, it is possible to rotate the vessel about one or more axes or to set it in tumbling motion. This results in vigorous mixing of the pulverulent wax and the foam particles with one another and accumulation of the wax at the surface of the foam particles. The greater the force with which the foam particles impact one another or the wall, the better the adhesion of the wax to the foam particles.

When the wax is applied to the foam particles in powder form, it is preferable when the ratio of pellets to wax is in the range from 0.001% to 0.5% by weight, based on the total mass of the foam particles, more preferably in the range from 0.005% to 0.25% by weight and especially 0.01% to 0.1% by weight. This amount is sufficient to accumulate sufficient wax on the surface of the foam particles. The individual pellets of the wax in powder form preferably have a particle diameter D50 in the range from 10 to 50 μm.

The wax is preferably applied to the foam particles in variant (ii) at ambient pressure and ambient temperature. However, it is also possible to apply the wax to the foam particles at elevated pressure or elevated temperature. In order to prevent foam particles from agglomerating, the wax is applied at a temperature below the softening temperature. Particular preference is given, however, to applying the wax at ambient temperature.

The wax acting as lubricant is preferably ethylenebisstearylamide. The use of ethylenebisstearylamide as lubricant has the advantage that this does not hinder the processing of the foam particles and hence need not be washed off in an additional process step.

A suitable thermoplastic elastomer in the context of the present invention is any thermoplastic elastomer which can be expanded to foam particles and pellets of which can be impregnated with a blowing agent by the above-described process. Suitable thermoplastic elastomers are known per se to those skilled in the art. Suitable thermoplastic elastomers are described, for example, in “Handbook of Thermoplastic Elastomers”, 2nd edition, June 2014.

For example, the thermoplastic elastomer may be a thermoplastic polyurethane, a thermoplastic polyetheramide, a polyetherester, a polyesterester, a thermoplastic olefin-based elastomer, a crosslinked thermoplastic olefin-based elastomer, or a thermoplastic vulcanizate or a thermoplastic styrene-butadiene block copolymer. The thermoplastic elastomer is preferably a thermoplastic polyurethane, a thermoplastic polyetheramide, a polyetherester or a polyesterester. The thermoplastic elastomer is more preferably a thermoplastic polyurethane.

### EXAMPLES

For the experiments, three thermoplastic polyurethanes (TPUs) that differed merely in terms of their melt flow rate (MFR, determined to DIN EN ISO 1133:2012-03) were utilized as precursors. The production of the expanded thermoplastic polyurethane (e-TPU) is described hereinafter. In order to apply the wax in solid form (experiment I), a batch mixer was connected downstream of the drying operation in a bulk flow heat exchanger (BFHE). Application by means of suspension is effected in two different ways (experiments II and III). For experiment II, the polymer particles were removed downstream of the BFHE and coated in a laboratory mixer. For experiment III, the lubricant was added in the pelletizing chamber.

The composition of the TPU and the melt flow rates of the different TPUs are listed in table 1.

TABLE 1
Composition of the precursor (TPU)

| Constituents | TPU 1 | TPU 2 | TPU 3 |
|---|---|---|---|
| Polyether-based polyol having | 1000 | 1000 | 1000 |
| an OH number of 112.2 and primary | | | |
| OH groups (based on tetramethylene | | | |
| oxide (functionality: 2) | | | |
| [parts by weight] | | | |
| Aromatic isocyanate (4,4′- | 500 | 500 | 500 |
| methylene diphenyl diisocyanate) | | | |
| [parts by weight] | | | |
| Butane-1,4-diol | 89.9 | 89.9 | 89.9 |
| [parts by weight] | | | |
| Stabilizer | 25 | 25 | 25 |
| [parts by weight] | | | |
| Tin(II) isooctanoate catalyst | 50 ppm | 50 ppm | 50 ppm |
| (50% in dioctyl adipate) | | | |
| [parts by weight] | | | |
| MFR at 190° C./21.6 kg | 26 | 31 | 38 |
| (g/10 min) | | | |

### Production of the e-TPU for Experiments I and II

The e-TPU is produced in a twin-screw extruder (Berstorff ZE 40) having a 44 mm screw and an L/D ratio of 48, followed by a melt pump, a slide valve with screen changer, a die plate and a pelletizing chamber for underwater pelletization. The TPU was predried down to a residual moisture content of less than 0.02% by weight at 80° C. for 3 h.

As well as the TPU, 1% by weight of a further thermoplastic polyurethane is metered in (modified TPU). This modified TPU is a TPU that was compounded in a separate extrusion process with diphenylmethane 4,4′-diisocyanate having an average functionality of 2.05.

After the metered addition, the materials are melted in the extruder and mixed. Subsequently, a mixture of CO₂ and N₂ is added as blowing agent. The polymer is mixed homogeneously in the remaining extruder zones. This mixture is forced by a melt pump through the slide valve and the screen changer and ultimately through a die plate into the pelletizing chamber. The mixture is cut into pellets therein and foamed in a pressurized, temperature-controlled water system. The flow of water transports the beads thus produced to a centrifugal dryer in which they are separated from the water stream. The total extruder throughput was adjusted to 40 kg/h (including polymers, blowing agents).

The process parameters for the production of the e-TPU are compiled in table 2.

TABLE 2
Process conditions in foaming

| | | | Slide | Die | | Pelletizing |
|---|---|---|---|---|---|---|
| | | Extruder | valve | plate | Pressure | chamber |
| | | temper- | temper- | temper- | Pelletizing | temper- |
| eTPU | TPU | ature | ature | ature | chamber | ature |
| particles | used | (° C.) | (° C.) | (° C.) | (bar) | (° C.) |
| Reference | TPU 1 | 170-220 | 175 | 220 | 15 | 40 |
| 1 | | | | | | |
| Reference | TPU 2 | 190-220 | 175 | 220 | 15 | 40 |
| 2 | | | | | | |
| Reference | TPU 3 | 170-220 | 175 | 220 | 15 | 40 |
| 3 | | | | | | |
| Example 6 | TPU 3 | 170-220 | 175 | 220 | 15 | 40 |

The composition of the blowing agent is detailed in table 3.

TABLE 3
Blowing agent composition used and blowing
agent metered in in the pelletizing chamber

| | | | | Concentration |
|---|---|---|---|---|
| | CO₂ | N₂ | | [% by wt. |
| eTPU particles | [% by wt.] | [% by wt.] | Lubricant | in water] |
| Reference 1 | 1.8 | 0.1 | | |
| Reference 2 | 1.8 | 0.1 | | |
| Reference 3 | 1.8 | 0.1 | — | — |
| Example 6 | 1.8 | 0.1 | Distearylethylenediamide | 0.034 |

### Experiment I. Application of the Lubricant in Powder Form

In a twin-shaft mixer (model: MBZ 350 from Derichs) with a net capacity of 200 l, 15 kg of expanded thermoplastic polyurethane in the form of expanded particles having an average diameter of 7.1 mm was mixed with a wax as lubricant corresponding to table 4 at a speed of 85 rpm at room temperature and ambient pressure for 3 minutes. In the case of nonspherical particles, for example elongated cylindrical particles, the diameter means the longest dimension.

TABLE 4
Amount of lubricant applied in powder form

| | | | | Lubricant |
|---|---|---|---|---|
| | | | | concen- |
| | | | | tration |
| | | | Amount | after |
| | | | of | appli- |
| | | | lubricant | cation |
| E-TPU | TPU | Lubricant | [g] | [% by wt.] |
| Reference 1 | TPU 1 | — | — | — |
| Example 1 | TPU 1 | Distearylethylenediamide | 5 | 0.025 |
| Example 2 | TPU 1 | Distearylethylenediamide | 10 | 0.05 |
| Example 3 | TPU 1 | Distearylethylenediamide | 30 | 0.15 |
| Comparative | TPU 1 | Silicon | 5 | 0.025 |
| example 1 | | dioxide | | |
| Comparative | TPU 1 | Silicon | 10 | 0.05 |
| example 2 | | dioxide | | |
| Comparative | TPU 1 | Silicon | 30 | 0.15 |
| example 3 | | dioxide | | |
| Comparative | TPU 1 | Calcium | 10 | 0.05 |
| example 4 | | stearate | | |
| Comparative | TPU 1 | Calcium | 30 | 0.15 |
| example 5 | | stearate | | |

### Experiment II. Application of Lubricant as a Suspension (Laboratory Experiments: Subsequent Application)

In a laboratory mixer with a capacity of 20 l, 2 kg of expanded thermoplastic polyurethane in the form of expanded particles having an average diameter of 7.1 mm was mixed with 15 kg of aqueous suspension of a lubricant for 5 minutes. The proportions of lubricant in the suspension are listed in table 5. After the mixing of the particles of expanded thermoplastic polyurethane with the suspension, the particles were separated from the suspension and dried at 60° C. and ambient pressure for 3 h.

TABLE 5
Amount of the lubricant in the suspension

| | | | Concentration |
|---|---|---|---|
| E-TPU | TPU | Lubricant | [% by wt. in water] |
| Reference 2 | TPU 2 | | 0 |
| Example 4 | TPU 2 | Distearylethylenediamide | 0.0034 |
| Example 5 | TPU 2 | Distearylethylenediamide | 0.034 |
| Comparative | TPU 2 | Distearylethylenediamide | 1.02 |
| example 6 | | | |

### Experiment III. Application of Lubricant as a Suspension (Application in a Pelletizing Chamber)

As described above, the lubricant was metered in during the foaming process in the extruder in the pelletizing chamber for the underwater pelletization. The concentration used is listed in table 3.

### Results of Experiments I to III—Tendency to Blocking

The tendency of the particle to blocking was assessed for all materials except for reference numeral 3 and example 6 by a simple caking test according to method 1. For reference 3 and example 6, the assessment was effected by the introduction of the fresh material into 200 l metal drums that were lined with an inliner of polyethylene film on the inside. The drum was filled with material produced and, directly after filling, heated in an air circulation oven at 60° C. for 2 h and then stored under ambient conditions (˜25° C.) for 12 days. After 12 days, the drums were pivoted by 150° with the aid of a lift apparatus, such that the opening pointed downward. If the material flows out of the metal drum under gravity alone as a result of the oblique surface, it is considered not to be blocked. If the material remains within the metal drum in spite of rotation, it is considered to be blocked.

The results are shown in table 10. In all examples and comparative examples, compared to an expanded thermoplastic polyurethane treated with a lubricant (references 1, 2 and 3), a reduction in blocking was observed.

TABLE 10
Results of the caking test experiments

| Examples | Blocking |
|---|---|
| Reference 1 | yes |
| Example 1 | no |
| Example 2 | no |
| Example 3 | no |
| Comparative example 1 | no |
| Comparative example 2 | no |
| Comparative example 3 | no |
| Comparative example 4 | no |
| Comparative example 5 | no |
| Reference 2 | yes |
| Example 4 | no |
| Example 5 | no |
| Comparative example 6 | no |
| Reference 3 | yes |
| Example 6 | no |

### Results of Experiments I to III—Weldability

After the lubricant has been applied, the particles thus treated and the reference materials are used to produce square sheets having a side length of 200 mm and a thickness of mm for mechanical testing. For this purpose, the particles are welded in a molding machine from Kurtz ersa GmbH (Energy Foamer K68) by contacting with steam. The welding parameters of the reference, examples and comparative examples are chosen such that the surfaces of the final molding have a minimum number of collapsed eTPU particles. The welding is followed by cooling for 120 s (both from the fixed and from the moving side of the mold) before the mold is opened. The respective steaming conditions are listed in table 6 in terms of the vapor pressures and the relative steaming time. The sheets obtained are subjected to heat treatment at 70° C. for 4 h.

Tables 6a and 6b: Positive steam pressures and times for welding of
the materials of the reference, examples and comparative examples

| | | Gap | Gap | Gap | Gap |
|---|---|---|---|---|---|
| | | steaming on | steaming | steaming on | steaming |
| | Gap | fixed side | on fixed | moving side | on moving |
| Example | (mm) | (bar) | side (s) | (bar) | side (s) |
| Ref. 1 | 14 | 1 | 20 | 1 | 20 |
| Ex. 1-3 | 14 | 1 | 20 | 1 | 20 |
| Comp. 1-5 | 14 | 1 | 20 | 1 | 20 |
| Ref. 2 | 14 | — | — | 0.6 | 16 |
| Ex. 4-5 | 14 | — | — | 0.6 | 16 |
| Comp. 6 | 14 | — | — | 0.6 | 16 |
| Ref. 3 | 14 | — | — | — | — |
| Ex. 6 | 14 | — | — | — | — |

| | Cross- | Cross- | Cross- | Cross- | Autoclave | |
|---|---|---|---|---|---|---|
| | steam on | steam on | steam on | steam on | steam | |
| | fixed side/ | fixed side/ | moving side/ | moving side/ | fixed/ | Autoclave |
| | backpressure | backpressure | backpressure | backpressure | moving side | steam |
| Component | (bar) | (s) | (bar) | (s) | (bar) | (s) |
| Ref. 1 | 1.3 | 40 | 1.1 | 20 | 1.3/0.8 | 10 |
| Ex. 1-3 | 1.3 | 40 | 1.1 | 20 | 1.3/0.8 | 10 |
| Comp. 1-5 | 1.3 | 40 | 1.1 | 20 | 1.3/0.8 | 10 |
| Ref. 2 | 1.3 | 30 | — | — | 1.3/0.8 | 10 |
| Ex. 4-5 | 1.3 | 30 | — | — | 1.3/0.8 | 10 |
| Comp. 6 | 1.3 | 30 | — | — | 1.3/0.8 | 10 |
| Ref. 3 | 0.8 | 20 | 0.8 | 20 | 1.95/1.95 | 60 |
| Ex. 6 | 0.8 | 20 | 0.8 | 20 | 1.95/1.95 | 60 |

In relation to the mechanical stability of the sheets produced, tensile strength measured by method 2 was employed. The specification to be attained was fixed at 1.0 MPa. The results of the tensile strength test are listed in table 7.

TABLE 7
Tensile strength and density of the specimens
used for the measurement (measured by method 2)

| | Density | Tensile strength |
|---|---|---|
| Examples | [g/l] | [MPa] |
| Reference 1 | 280 | 1.34 |
| Example 1 | 313 | 1.23 |
| Example 2 | 304 | 1.29 |
| Example 3 | 298 | 1.34 |
| Comparative example 1 | 297 | 0.70 |
| Comparative example 2 | 287 | 0.55 |
| Comparative example 3 | 295 | 0.46 |
| Comparative example 4 | 300 | 0.83 |
| Comparative example 5 | 301 | 0.34 |
| Reference 2 | 264 | 1.38 |
| Example 4 | 265 | 1.41 |
| Example 5 | 268 | 1.15 |
| Comparative example 6 | * | * |
| Example 6 | 354 | 1.29 |

*Sheets fall apart on demolding, and so no test was possible

### Methods

### Method 1: Caking Test

The test setup consists of two components: a stainless steel cylinder (consisting of 2 half-shells held together with the aid of a hose clamp and a clamp stand on which a movable ram having a mass of about 1 kg is fixed. The cylinder has a diameter of 11 mm; that of the ram is somewhat smaller in order it can slide without contact into the cylinder when the latter is centered below it. For the test, the cylinder is filled completely with e-TPU. Thereafter, the ram is placed onto the e-TPU without pressure. It must be ensured here that the ram is not resting on the cylinder anywhere. The weight thus applied to the e-TPU is supposed to simulate the pressure that would act on the material within an octabin or bigbag. The test setup is stored at 30° C. for 10 days. Subsequently, the ram is raised cautiously and the hose clamp is removed. If the material remains standing as a cylinder when the half-shells are pulled apart, the material is considered to be blocked. If the material collapses, it is considered to be not to be blocked.

### Method 2: Tensile Strength

Tensile strength is determined for a sheet thickness of 10 mm (thickness may vary slightly depending on shrinkage) in accordance with ASTM D5035, 2015, which was drawn up for textiles. The determination is effected with a tester equipped with a 1 or 2.5 kN load cell (class 0.5 (from 10 N) according to DIN EN ISO 7500-1, 2018), extensometer, traverse (class 1 or better according to DIN EN ISO 9513, 2013) and pneumatic clamps (6 bar (with clamp jaw inserts of a pyramid pattern (Zwick T600 R)). The specimens required of punched out of a 200×200×10 mm test sheet in a size of 150 mm×25.4 mm (dimensions may vary slightly depending on shrinkage). The test sheets used were conditioned beforehand under standard climatic conditions (23±2° C. and 50±5% humidity) for 16 h. Tensile testing was likewise effected under these standard climatic conditions. Before measurement, the mass (precision balance; accuracy: ±0.001 g) test specimens and the thickness thereof (slide rule; accuracy: ±0.01 mm, contact pressure 100 Pa, value is determined just once at the middle of the test specimen) are determined. The mass, the measured thickness and the fixed values for length (150 mm) and width (25.4 mm) are used to calculate the density in kg/m². These values are reported in the test method.

The distance between the clamps (75 mm) and the extension of the extensometer (50 mm) are checked prior to commencement of the test. The test specimen is placed onto the upper clamp and the force is tared. The test specimen is clamped and the test is commenced. The measurement is effected at a testing speed of 100 mm/min and an initial force of 1 N. Tensile strength σₘₐₓ (reported in MPa) is calculated by equation (1); it is the maximum stress, which can be identical to the stress on fracture. Elongation at break ϵ (reported in %) is calculated by equation (2). Three test specimens are tested for each material. The average from the three measurements is reported. If the test specimen breaks outside the marked region, this is noted. There is no repetition with a further test specimen.

$${σ}_{max} = \frac{{F}_{max}}{d \text{?} b} \qquad ( 1 )$$

$$\text{?} \text{indicates text missing or illegible when filed}$$

Fₘₐₓ=maximum force on tearing of the test specimen [N]
d=thickness of the test specimen [mm]
b=width of the test specimen [mm]

$$\text{?} = \frac{{L}_{B} - {L}_{0}}{{L}_{0}} \text{?} 100 \% \qquad ( 2 )$$

$$\text{?} \text{indicates text missing or illegible when filed}$$

L_{B}=length at break [mm]
L₀=starting length (distance between the measurement markings [mm])

1. A process for producing foam particles from expanded thermoplastic elastomer, the process comprising:
(a) mixing a thermoplastic elastomer melt with a blowing agent in an extruder:
(b) pressing the thermoplastic elastomer melt mixed with the blowing agent through a die plate into a pelletizing chamber; and
(c) comminuting the thermoplastic elastomer melt mixed with the blowing agent that has been pressed through the die plate into individual pellets,
wherein a liquid flows through the pelletizing chamber, and a pressure and temperature of said liquid are chosen such that the pellets are expanded to a desired degree in the liquid by the blowing agent present and solidify to form foam particles,
wherein at least one of the following features is encompassed:
(i) the liquid in the pelletizing chamber comprises wax, which accumulates on a surface of the pellets during cutting and expansion in the pelletizing chamber,
(ii) after separation from the liquid and drying of the foam particles, a wax is applied to the foam particles of expanded thermoplastic elastomer.

2. The process according to claim 1, wherein the liquid in the pelletizing chamber comprises a wax and is in the range from 0.01% to 5% by weight, based on a total mass of the liquid.

3. The process according to claim 1, wherein the liquid is water and optionally comprises suspension media.

4. The process according to claim 1, wherein the wax is dissolved in the liquid or is dispersed in the liquid in solid form with a particle diameter D50 in the range from 10 to 50 μm.

5. The process according to claim 1, wherein the liquid in the pelletizing chamber is at a pressure in the range from 1 to 20 bar.

6. The process according to claim 1, wherein the liquid in the pelletizing chamber is at a temperature in the range from 20 to 90° C.

7. The process according to claim 1, wherein the wax is applied to the foam particles after separation from the liquid and optionally drying, wherein the wax is applied in powder form.

8. The process according to claim 7, wherein the wax applied in powder form has a particle diameter D50 in the range from 10 to 50 μm.

9. The process according to claim 7, wherein the wax and the foam particles are introduced into a vessel, which is then closed and subsequently agitated.

10. The process according to claim 9, wherein the a ratio of pellets to wax is in the range from 0.01% to 0.5% by weight.

11. The process according to claim 7, wherein the wax is applied to the foam particles at ambient temperature and ambient pressure.
